(19) United States
(12) Patent Application Publication
(10) Pub. No.: US 2017/0124507 A1
(43) Pub. Date: May 4, 2017

(54) Workflow Management Using Third-Party Templates

(71) Applicant: MICROSOFT TECHNOLOGY LICENSING, LLC, Redmond, WA (US)

(72) Inventors: Sree Hari Nagaralu, Hyderabad (IN); Ranganath Kondapally, Hyderabad (IN); Karthikeyan Raman, Hyderabad (IN); Venkata Sai Ravali Busetty, Hyderabad (IN); Pavan Kumar Dasari, Hyderabad (IN)

(73) Assignee: MICROSOFT TECHNOLOGY LICENSING, LLC, Redmond, WA (US)

(21) Appl. No.: 14/927,980

(22) Filed: Oct. 30, 2015

(51) Int. Cl. G06Q 10/06; H04L 12/58

(52) U.S. Cl. CPC G06Q 10/063114; H04L 51/22

(57) ABSTRACT

Systems and methods for providing workflow management regarding received messages from a provider are presented. In operation, a workflow management service is notified of a received message from the provider and, in response, identifies a third party template associated with the receiving user that is applicable to the first message according to an applicability condition of the first third party template. After identifying a third party template, a template rule is identified from the third party template, where the template rule is applicable to the received message according to an analysis of the message. An action is implemented, the action being associated with the received template rule with regard to a workflow status of a workflow corresponding to the third party template. The workflow status of the workflow is updated according to the results of implementing the action.

### BACKGROUND

As people become more and more reliant upon computer and computing devices to interact with businesses, services, and other people, there has been a substantial increase in the electronic messages are sent back and forth. For example, when a person orders an item from an online store, that person will typically receive multiple email messages (or some other form of electronic message) that indicates the current status of the order. Illustratively, these multiple messages will frequently include one or more of a confirmation of the order, an invoice, an indication that the order is being processed, a message that the item is backordered, a message regarding an expected shipping date, a message that the item is being shipped, a tracking number for the item (during shipment), an indication that the item has been delivered, and a request for user feedback regarding the item and the seller.

In the face of so many messages surrounding any one user action/event, it is often difficult to keep track of the current status of any particular item. With regard to the previous example, the purchaser must keep track of all of the messages regarding the particular transaction and review the messages in order to ascertain the current status of the purchase transaction. Unfortunately, these messages are most likely not grouped together in a meaningful way including not utilizing the same messaging thread. Of course, a user could create a rule to forward messages from a particular vendor, or based on some language in a subject line or message body, to a particular folder, but collecting messages to a folder simply identifies potentially relevant messages (assuming that all relevant messages are collected by a particular rule that forward the messages to the common folder) and still leaves the person to sort through the message to comprehend the current status, or take a particular action with regard to an action or event.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

According to aspects of the disclosed subject matter, systems and methods for providing workflow management regarding received messages from a provider are presented. In operation, a workflow management service is notified of a received message from the provider and, in response, identifies a third party template associated with the receiving user that is applicable to the first message according to an applicability condition of the first third party template. After identifying a third party template, a template rule is identified from the third party template, where the template rule is applicable to the received message according to an analysis of the message. An action is implemented, the action being associated with the received template rule with regard to a workflow status of a workflow corresponding to the third party template. The workflow status of the workflow is updated according to the results of implementing the action.

According to additional aspects of the disclosed subject matter, a method for managing a workflow related to a user in regard to one or more received messages is presented. A message directed to the user is received and a third party template associated with the user is identified. The third party template is identified on the basis that it is applicable to the first message according to an applicability condition of the third party template. A template rule of the third party template is then identified. The template rule is applicable to the first message according to an analysis of the received message. Thereafter, a first action associated with the first template rule is implemented with regard to a workflow status of a workflow corresponding to the third party template, and the workflow status of the workflow is updated.

According to still further aspects of the disclosed subject matter, a computing system for managing a workflow of a user in regard to one or more received messages is presented. The computing system includes a processor and a memory, wherein the processor executes instructions stored in the memory as part of or in conjunction with additional components to manage the workflow of the user. These additional components include a messaging service component and a workflow management component. The messaging service component is configured to provide a messaging service on the computing system and the workflow management component is configured to provide a workflow management service on the computing system. In operation, the workflow management service, upon receiving notice of the messaging service receiving a message for the user, identifies a third party template associated with the user that is applicable to the received message. The third party template is identified according to an applicability condition of the third party template. After identifying the third party template, a template rule of the first third party template is identified. The template rule is applicable to the first message according to an analysis of the received message. An action associated with the template rule is implemented with regard to a workflow status of a workflow corresponding to the third party template, and the workflow status of the workflow is updated according to the results of implementing the action of the template rule.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is block diagram illustrating and exemplary network environment suitable for implementing aspects of the disclosed subject matter, and further an illustrating exemplary flow of information in regard to workflow management using third party defined templates;

FIG. 2 is a flow diagram illustrating an exemplary routine for receiving third party templates to be used in workflow management of a workflow according to aspects of the disclosed subject matter;

FIG. 3 is a flow diagram illustrating an exemplary routine for processing messages according to one or more third party templates;

FIG. 4 is a flow diagram illustrating an exemplary routine for displaying workflow status according to a third party template;

FIG. 5 is a pictorial diagram illustrating a visual presentation of a workflow according to aspects of the disclosed subject matter; and

FIG. 6 is a block diagram illustrating components of an exemplary computing device suitably configured according to aspects of the disclosed subject matter.

### DETAILED DESCRIPTION

For purposes of clarity, the term “exemplary,” as used in this document, should be interpreted as serving as an illustration or example of something, and it should not be interpreted as an ideal and/or a leading illustration of that thing.

By way of definition and for purposes of clarity, aspects of a relationship between a service and a user, as managed by a workflow management service described herein, will be referred to as a workflow. Moreover, the current status of the workflow (i.e., the aspects of the relationship) managed by the workflow management service is referred to as the workflow status.

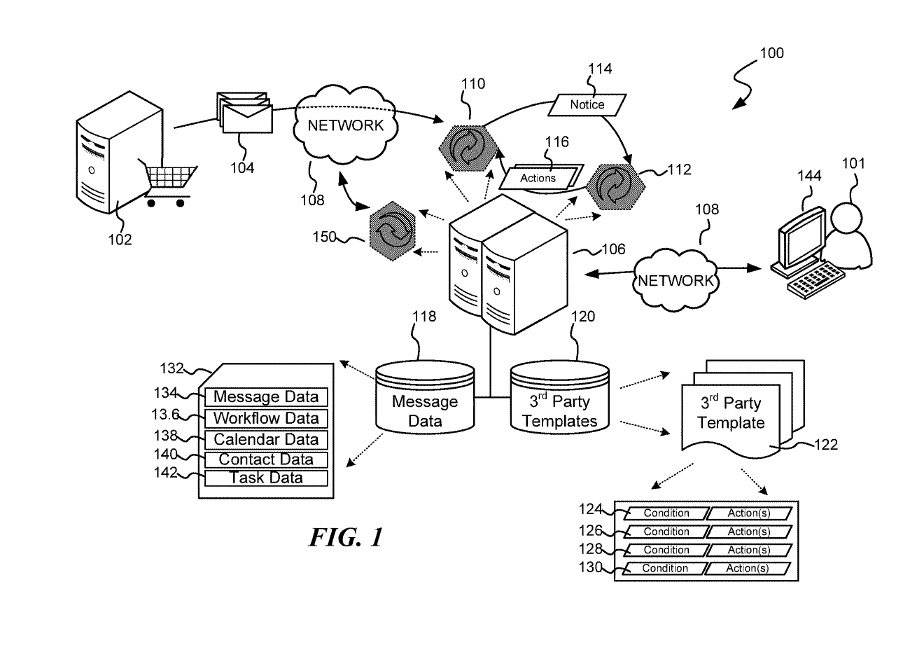

Turning now to FIG. 1, is block diagram illustrating and exemplary network environment 100 suitable for implementing aspects of the disclosed subject matter, and further illustrating an exemplary flow of information in regard to workflow management using third party defined templates. As shown in FIG. 1, the exemplary network environment 100 includes various third party services, such as retail service 102, connected, via a network 108, and a messaging host computing device 106. As will readily appreciated, the third party services, such as retail service 102, may send one or more messages, such as message 104, to a user 101 on a user computing device 144 via the messaging host computing device 106. Indeed, one or more processes operating on the messaging host computing device 106 receive the messages on behalf of the user 101 and, at least temporarily, store the messages for subsequent access and/or retrieval by the user via the user's computing device 144. The messages are stored in a message data store 118 associated with or a part of the messaging host computing device 106. As will be further appreciated, typically, though not exclusively, the messaging processes operating on the messaging host computing device 106 store a set of user data, such as user data 132, for a plurality of users.

A messaging service 110, operating as one or more processes on the messaging host computing device 106, interacts with other sources over the network 108, such as retail service 102, to receive messages on behalf of various users, including user 101. In addition to storing the received message, such as message 104, in the user data 132 corresponding to the user 101 and according to aspects of the disclosed subject matter, the messaging service is further configured such that, upon receiving the message on behalf of the user, a workflow management service 112 is notified (via notice 114) of the received message. The workflow management service 112 makes a determination as to whether one or more third party templates, stored in a third party template store 120 associate with or a part of the messaging host computing device 106, are applicable to the message such that a workflow status should be updated. Upon a determination by the workflow management service 112 that one or more third party templates are applicable to the received message, one or more actions, such as action 116, are taken to update a workflow status of the workflow to which the received message is applicable.

In regard to the messaging service 110 and the workflow management service 112, while these are illustrated as separate processes executing on the messaging host computing device 106, this should be viewed as illustrative of one embodiment and shown in this manner for clarity in discussion, and should not be construed as limiting upon the disclosed subject matter. Indeed, in various embodiments, the messaging service 110 and the workflow management service 112 may be implemented as a single process implemented on the messaging host computing device 106. Further, while the messaging host computing device 106 is separate from the user computing device 144, this too is for illustration purposes and should not be viewed as limiting upon the disclosed subject matter. According to various alternative embodiments, the messaging host computing device 106 and the user computing device 144 may be implemented upon the same computing device.

According to aspects of the disclosed subject matter, the work flow management service 112 maintains information regarding one or more workflows corresponding to the user 101 as workflow data in the user data 132 associated with the user. Indeed, according to aspects of the disclosed subject matter, the messaging service 110 and the work flow management service 112 collectively maintain both message data 134 (corresponding to one or more messages) and workflow data 136 (corresponding to one or more workflows) in that user data 132 (or user data set) maintained for the user 101. As illustrated in FIG. 1, in addition to message data 134 and workflow data 136, the messaging service 110 and the work flow management service 112 collectively may also optionally maintain other information corresponding to the user 101 including, by way of illustration, calendar data 138, contact data 140, and task data 142. As suggested above, the messaging service 110 and the work flow management service 112 typically maintain user data sets as described in regard to user data 132 for a plurality of users, each user data set stored in the message data store 118.

As indicated above, upon receiving notice of a received message, the work flow management service 112 determines whether one or more third party templates, such as third party template 122, are applicable to the received message. By way of definition, a third party template corresponds to a template for managing a particular workflow. For each third party template, such as third party template 122, there is a corresponding workflow in the workflow data 136. These templates are “third party” templates in the sense that they are not part of the messaging application (or other application) that displays the messages. Rather, they are designed by “others,” i.e., third parties, such that they extend the ability of the messaging application in regard to managing workflow statuses. Third party templates may be obtained from services that may send a plurality of messages regarding a particular workflow, from private individuals, and the like. Third party templates may also be generated by the user 101 of the computing device.

A third party template is applicable to a received message when, in an evaluation of the received message, one or more conditions of applicability associated with the third party template are met. According to aspects of the disclosed subject matter and by way of illustration, a condition may correspond to a unique identifier in a subject line (or body) of the received message, such as a purchase order or invoice number. Additionally and illustratively, a condition may correspond to a combination of a message sender and a particular set of characters in the subject line and/or body of the received message. According to aspects of the disclosed subject matter, one or more criteria may be established as a condition based on any of (by way of illustration and not limitation) the sender, the date and/or time of the message, any or all of the subject matter of a subject associated with the message, any or all of the subject matter of the body of a message, header information of the received message, and the like. Each third party template, such as third party template 122, includes the conditions upon which the template may be viewed as being applicable to a received message.

In addition to including conditions upon which a third party template may be viewed as being applicable to a received message, each third party template, such as third party template 122, further comprises a set of tuples, each tuple comprising a condition and one or more corresponding actions. These tuples, such as tuples, 124-130, include a condition and one or more corresponding actions. In short, when a condition in a received message is met, the one or more corresponding actions are carried out. As with the conditions for applicability to a received message, these conditions may include the particular sender, the date and/or time of the message, the subject matter of the subject line and/or body of the message, header and metadata information regarding the message, and the like. Additionally, conditions may be based on a combination of criteria and may include logical and/or arithmetic operators and operands.

An action may be viewed as an activity to carry out based on the subject matter of the received message and the current workflow status of the corresponding workflow. Actions may include generating display information according to display templates of the third party template, updating the workflow status of the workflow associated with the third party template, storing data with regard to the workflow, performing arithmetic and logic calculations and/or data manipulations, managing lists and sets, conditionally executing according to existing conditions, executing macros and executable code, obtaining external data, and the like.

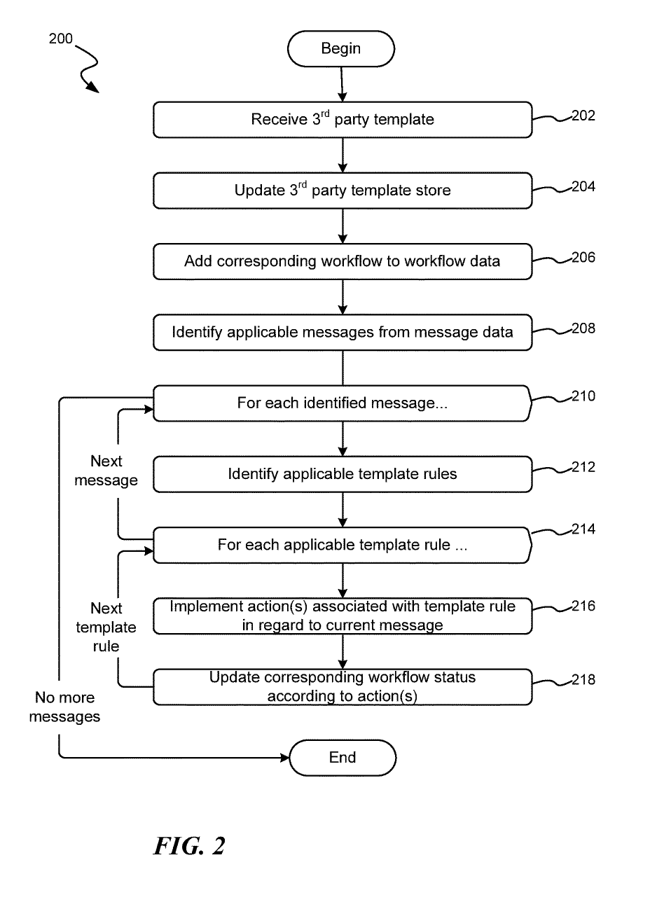

With regard to third party templates and obtaining these templates such that they extend the ability of a messaging application to manage and display a workflow status, reference is now made to FIG. 2. FIG. 2 is a flow diagram illustrating an exemplary routine 200, as may be implemented on a messaging host computing device 106, for receiving third party templates to be used in workflow management of a workflow according to aspects of the disclosed subject matter. Beginning at block 202, a third party template is received. At block 204, the third party template store 120 is updated with the newly received template, such as template 122 of FIG. 1. At block 206, a workflow is added to the workflow data in the user data set 132 corresponding to the user 101. According to various aspects of the disclosed subject matter, the third party template will typically identify an initial state of the workflow in the workflow data 136 and the workflow is set to that state in adding it to the workflow data.

At block 208, current messages (i.e., those that the user has already received) to which the newly added workflow is applicable are identified. According to aspects of the disclosed subject matter, those messages that are maintained in the message data 134 of the user's user data set 132 are evaluated in regard to whether the newly added template is applicable. According to aspects of the disclosed subject matter, previously received messages that have been deleted (yet stored in a “trash” folder) may be skipped from this evaluation.

At block 210, an iteration loop is begin to iterate through the identified messages. Selecting a first message (typically the oldest received message and processed in order of receipt) as the currently iterated message, the routine proceeds to block 212. At block 212, template rules of the newly received third party template that are applicable to the currently iterated message are identified. At block 214, another iteration loop is begun to iterate through the identified template rules. With a currently iterated template rule, at block 216 the actions associated with the template rule are implemented with regard to the currently iterated message. At block 218, the workflow status for the workflow of the newly added third party template is updated. Thereafter, the routine 200 returns to block 214 to iterate to another template rule. This iteration continues until, at block 214, there are no more template rules to process with regard to the currently iterated message, at which point the routine 200 returns to block 210 to iterate to another identified message to which the newly received third party template is applicable. As with other iteration loops, this process continues until, at block 210, there are no more identified messages, at which point the routine 200 terminates, having updated the workflow status of the workflow for this newly received third party template.

While third party templates may be received from external sources, e.g., from common, shared libraries of third party templates, from vendors, and the like, according to aspects of the disclosed subject matter and with reference, again, to FIG. 1, a template acquisition process 150 may be executing on the messaging host computing device 106 to assist a computer user, such as computer user 101, in obtaining and/or defining third party templates. Indeed, according to aspects of the disclosed subject matter, the template acquisition process 150 may be configured to define and/or identify external third party templates that may be of assistance to the computer user in those circumstances in which the computer user has not already selected/implemented a third party template. These conditions may include, by way of illustration and not limitation, detecting a messages stream from a single source in which similar content is identified in a message body or a subject line, but that are not simply replies and/or forward of a same message.

By way of illustration and example, the template acquisition process 150 may detect a condition upon which multiple emails or other messages are received from another party, such as retail service 102, determine that the computer user has not provided any indication to utilize a third party template with regard to the email/messages, and may suggest to the computer user that one or more third party templates may be used. Indeed, upon detecting this condition (receiving messages that could be advantageously managed by one or more third party templates) the template acquisition process 150 may attempt to locate one or more third party templates that are suitable for the current set of messages, and/or assist the user in defining a third party template. For example, upon detecting the conditions upon which a third party template may be useful to the computer user 101, the template acquisition process 150 may first attempt to identify one or more third party templates from known locations (e.g., commercial and or public domain template libraries), that may be applicable to the current messages stream and, if successful in identifying any such third party templates, suggest them to the computer user. Further, if no third party templates are identified, the template acquisition process 150 may provide an environment that the computer user may optionally construct a third party template to process the message stream. Further still, the template acquisition process 150 may identify conditions in which the computer user utilized a third party template with regard to an earlier messages stream and suggest the application of that third party template with regard to the new message stream.

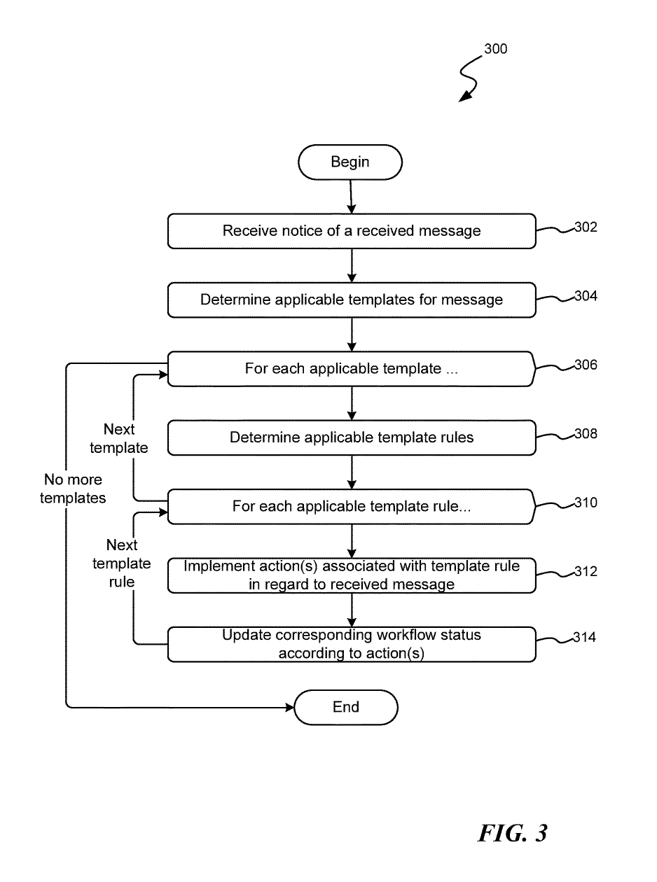

Turning now to FIG. 3, this figure is a flow diagram illustrating an exemplary routine 300 for processing received messages with one or more third party templates according aspects of the disclosed subject matter. Beginning at block 302, a notice regarding a received message is received. At block 304, an evaluation is conducted with regard to the received message to identify any third party templates that are applicable to the received message. As indicated above, this evaluation is based on conditions of applicability of a third party templates based on one or more criteria.

After identifying third party templates that are applicable to the received message, at block 306 an iteration loop is begun to iterate through all of the applicable third party templates. Thus, at block 308 and with regard to the currently iterated third party template, an evaluation is conducted to identify the condition/action(s) tuples, referred to hereafter as template rules, that are applicable to the received message, i.e., the template rules in which the conditions are met in the received message. As with the conditions of applicability of third party templates, conditions of template rules may be based on any number of factors and criteria associated with the received message as well as the current workflow status of the corresponding workflow. These conditions may include, by way of illustration and not limitation, current values associated with data in the workflow and/or within the receive message, dates and times of the received message, a sender or recipient of the received message, values that are externally obtained (i.e., outside of the messaging service and/or workflow management service, and the like as well as combinations of one or more factors based on Boolean, logical and/or arithmetic operations and operands.

At block 310, another iteration loop is begun, this time to iterate through the identified, applicable template rules of the currently iterated third party template. Thus, at block 312, the one or more actions of the currently iterated template rule is implemented/carried out with regard to the received message. As indicated above, in implementing the one or more actions, the workflow status of the workflow associated with the currently iterated third party template may be updated, actions related to but not specifically affecting the workflow status may be carried out, a presentation of the workflow (according to the current workflow status) may be generated, and the like. At block 314, the workflow status of the workflow is updated according to the actions (if there is any update).

After executing the actions of a first applicable template rule, the routine 300 returns to block 310 to iterate to the next applicable template rule and repeat the activities described in regard to blocks 312 and 314. This process continues until all of the applicable template rules have been processed, and the routine 300 returns to block 306 to process another identified third party template.

Once all third party templates identified as being applicable to the received message have been processed, the routine 300 terminates.

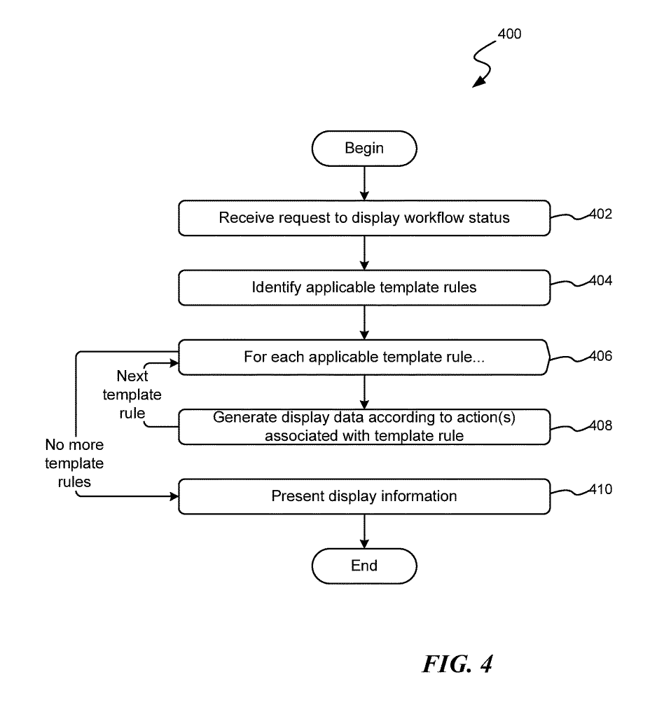

While FIG. 2 is particularly directed to receiving and processing a new third party template, and FIG. 3 is directed to processing received messages with one or more third party templates, FIG. 4 is more particularly directed to processing a request for display of a workflow status. As suggested above, the third party templates may include condition/action tuples (template rules) for displaying the workflow status of a workflow. Thus, FIG. 4 is a flow diagram illustrating an exemplary routine 400 for displaying workflow status according to a third party template. Beginning at block 402, a request to display the workflow status of a workflow according to a particular third party template is received.

At block 404, applicable template rules (for displaying the workflow status of the corresponding workflow) are identified. At block 406, an iteration loop is begun to iterate through each of the identified template rules. Thus, at block 408, display data regarding the corresponding workflow is generated according to the currently iterated template rule. Thereafter, the routine 400 returns to block 406 to process the next applicable template rule. After all identified template rules have been processed, the routine proceeds to block 410 were the generated display information is presented.

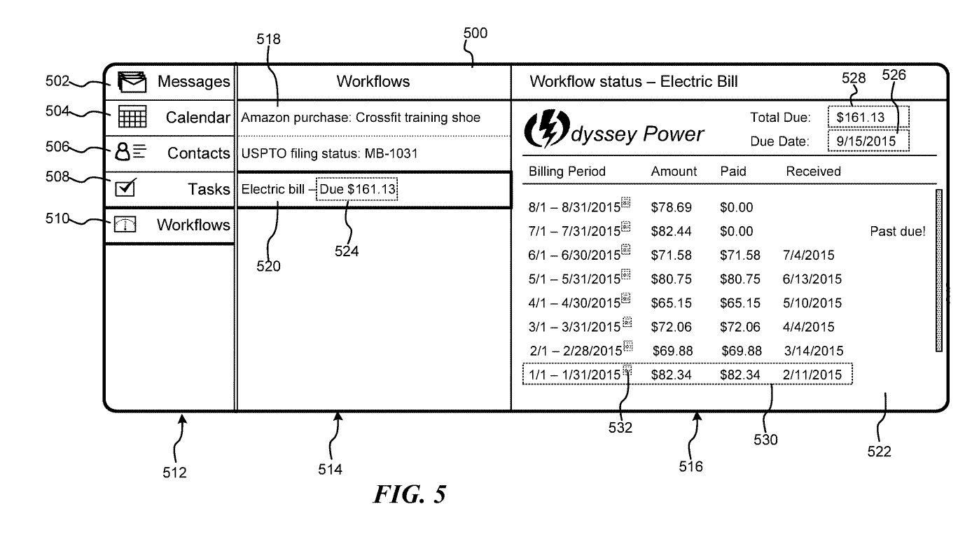

In regard to generating display information regarding a workflow, FIG. 5 is a pictorial diagram illustrating an exemplary application view 500 that includes the display of a workflow within an information management application. As shown in the exemplary application view 500, in a first portion 512 of the application view various controls 502-510 for displaying different sets of information, including messages, a calendar, contacts, tasks, and workflows, the control 510 for displaying workflows in the information management application is highlighted (as indicated by the darker border.) In a second portion 514 of the application view 500, the various workflows that are maintained by the information management application are listed, including workflows 518 and 520, with the workflow 520 being highlighted (as indicated by the darker border).

According to aspects of the disclosed subject matter, a third party template corresponding to a workflows may be configured to generate a single line display of the workflow, as illustratively shown in the second portion 514 of the application view 500, as well as a detailed display, such as workflow display 522 shown in the third portion 516 of the application view. Of course, as each third party template may define the elements of how the content is displayed, the display may include current information regarding the workflow status. For example, in regard to the single line display 520, the generated display includes the current amount due with regard to the electric bill, as indicated by field 524. As shown in the more detailed workflow display 522, information such as due dates (field 526), amounts due (field 528), prior bills with amounts both due and paid (field 530), as well as actionable controls (such as control 532) to view the corresponding bills may all be included in a generated detailed workflow display according to the various actions regarding display in a third party template. As suggested above, the actions of the template rules of a third party template for displaying a workflow may include, by way of illustration and not limitation, workflow status including data and data values stored in the workflow, executable code and/or scripts, audio/visual content, graphics and images, logical and/or arithmetic operators and operands, hyperlinks to external content, lists, actionable controls, labels and text, notifications, and the like. Indeed, though through the use of third party templates, sophisticate and customized presentations of information may be generated and displayed with regard to a workflow and the workflow status.

In regard to the exemplary application view 500 of the information management application, it should be appreciated that while the generated information is presented in the context of the information management application, this is illustrative of one embodiment and should not be construed as limiting upon the disclosed subject matter. Indeed, while the workflow management service 112 operates with regard to received messages that may be managed by an information management application, the presentation of the workflows is not limited to that application. Indeed, in various embodiments, the display of workflows may be presented by way of a workflow app (a lightweight executable application that is typically designed with a small set of functionality) which derives its contents from the received messages of the information management application but maintains its own set of workflow data.

Regarding routines 200, 300 and 400 described above, as well as other processes describe herein, while these routines/processes are expressed in regard to discrete steps, these steps should be viewed as being logical in nature and may or may not correspond to any actual and/or discrete steps of a particular implementation. Also, the order in which these steps are presented in the various routines and processes, unless otherwise indicated, should not be construed as the only order in which the steps may be carried out. In some instances, some of these steps may be omitted. Those skilled in the art will recognize that the logical presentation of steps is sufficiently instructive to carry out aspects of the claimed subject matter irrespective of any particular language in which the logical instructions/steps are embodied.

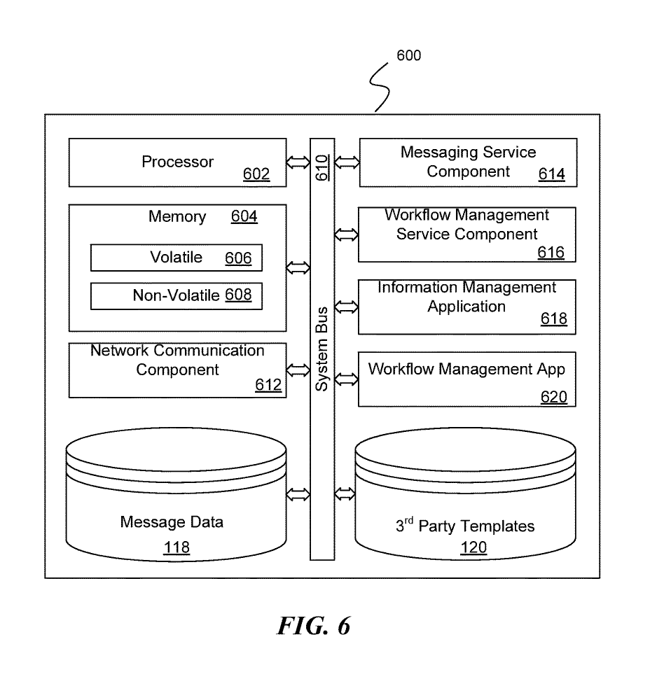

Of course, while these routines include various novel features of the disclosed subject matter, other steps (not listed) may also be carried out in the execution of the subject matter set forth in these routines. Those skilled in the art will appreciate that the logical steps of these routines may be combined together or be comprised of multiple steps. Steps of the above-described routines may be carried out in parallel or in series. Often, but not exclusively, the functionality of the various routines is embodied in software (e.g., applications, system services, libraries, and the like) that is executed on one or more processors of computing devices, such as the computing device described in regard FIG. 6 below. Additionally, in various embodiments all or some of the various routines may also be embodied in executable hardware modules including, but not limited to, system on chips, codecs, specially designed processors and or logic circuits, and the like on a computer system.

These routines/processes are typically embodied within executable code modules comprising routines, functions, looping structures, selectors such as if-then and if-then-else statements, assignments, arithmetic computations, and the like. However, the exact implementation in executable statement of each of the routines is based on various implementation configurations and decisions, including programming languages, compilers, target processors, operating environments, and the linking or binding operation. Those skilled in the art will readily appreciate that the logical steps identified in these routines may be implemented in any number of ways and, thus, the logical descriptions set forth above are sufficiently enabling to achieve similar results.

While many novel aspects of the disclosed subject matter are expressed in routines embodied within applications (also referred to as computer programs), apps (small, generally single or narrow purposed applications), and/or methods, these aspects may also be embodied as computer-executable instructions stored by computer-readable media, also referred to as computer-readable storage media, which are articles of manufacture. As those skilled in the art will recognize, computer-readable media can host, store and/or reproduce computer-executable instructions and data for later retrieval and/or execution. When the computer-executable instructions that are hosted or stored on the computer-readable storage devices are executed by a processor of a computing device, the execution thereof causes, configures and/or adapts the executing computing device to carry out various steps, methods and/or functionality, including those steps, methods, and routines described above in regard to the various illustrated routines. Examples of computer-readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. While computer-readable media may reproduce and/or deliver the computer-executable instructions and data to a computing device for execution by one or more processor via various transmission means and mediums including carrier waves and/or propagated signals, for purposes of this disclosure computer readable media expressly excludes carrier waves and/or propagated signals.

Advantageously, many of the benefits of the disclosed subject matter can be conducted on a wide variety of computing devices, including computing devices with limited computing capacity and/or storage capabilities. Indeed, suitable computing devices suitable for implementing all of some of the disclosed subject matter include, by way of illustration and not limitation any or all of: desktop computers; laptop computers; mini- and mainframe computers; mobile phones; tablet computers; “phablet” computing devices (the hybrid mobile phone/tablet devices); personal digital assistants; and the like.

Regarding the various computing devices upon which aspects of the disclosed subject matter may be implemented, FIG. 6 is a block diagram illustrating components of an exemplary computing device 600 suitably configured according to aspects of the disclosed subject matter. The exemplary computing device 600 includes one or more processors (or processing units), such as processor 602, and a memory 604. The processor 602 and memory 604, as well as other components, are interconnected by way of a system bus 610. The memory 604 typically (but not always) comprises both volatile memory 606 and non-volatile memory 608. Volatile memory 606 retains or stores information so long as the memory is supplied with power. In contrast, non-volatile memory 608 is capable of storing (or persisting) information even when a power supply is not available. Generally speaking, RAM and CPU cache memory are examples of volatile memory 606 whereas ROM, solid-state memory devices, memory storage devices, and/or memory cards are examples of non-volatile memory 608. While shown as being separate in FIG. 6, data stores such as the message data store 118 and the third party templates data store 120 may also be a part of memory 604, typically embodied as non-volatile memory 608.

Further still, the illustrated computing device 600 includes a network communication component 612 for interconnecting this computing device with other devices over a computer network, including other services and providers that send one or more messages to the messaging service 110. The network communication component 612, sometimes referred to as a network interface card or NIC, communicates over a network (such as network 108) using one or more communication protocols via a physical/tangible (e.g., wired, optical, etc.) connection, a wireless connection, or both. As will be readily appreciated by those skilled in the art, a network communication component, such as network communication component 612, is typically comprised of hardware and/or firmware components (and may also include or comprise executable software components) that transmit and receive digital and/or analog signals over a transmission medium (i.e., the network.)

The processor 602 executes instructions retrieved from the memory 604 (and/or from computer-readable media) in carrying out various functions, particularly in regard to responding to passively recording an ongoing audio or audio/visual stream and generating notes from the passive recordings, as discussed and described above. The processor 602 may be comprised of any of a number of available processors such as single-processor, multi-processor, single-core units, and multi-core units.

The exemplary computing device 600 further includes a messaging service component 614. The messaging service component may be embodied as an executable application, as hardware or firmware component, or a combination of both software (application) and hardware. In operation and/or execution, the messaging service component 614 implements the various functions of the messaging service process 110 described above in regard to FIG. 1. Similarly, the workflow management service component 616 may be embodied as an executable application, as hardware or firmware component, or a combination of both software (application) and hardware. In operation and/or execution the workflow management service component 616 implements the various functions of the workflow management service process 112 described above in regard to the exemplary network environment 100 of FIG. 1.

The information management application 618 is typically, but not necessarily, comprised of software instructions that form an application which, in execution on the processor 602, configures the computing device to provide the interfaces and functionality for the user of the computing device to interact with messages and other personal information tasks. The exemplary application view 500 of FIG. 5 is one illustrative example of user interfaces of the information management application 618. According to various embodiments, the information management application 618 may include the functionality for displaying workflow information as shown in FIG. 5. Moreover, according to various alternative embodiments of the disclosed subject matter, the exemplary computing device 600 may also include a workflow management app 620 (or application) that is specifically tailored to present workflow information generated according to one or more third party templates based on one or more received messages.

As indicated above, the exemplary computing device 600 also includes a message data store 118 as well as a third party templates store 120. As indicated above, the message data store is configured to store a set of user data, such as user data 132 of FIG. 1, for a plurality of users. The user data typically includes message data as well as workflow data. Alternatively, the workflow data may be stored apart from the message data in another data store, such as the third party templates store 120. As also indicated, the third party templates store 120 is configured to store one or more third party templates for one or more users.

Of course, the exemplary computing device 600 may further comprise additional components not specifically identified in FIG. 6. For example, those skilled in the art will appreciate that the exemplary computing device 600 will typically include an operating system component (including input/output subsystems), various hardware devices including user interaction devices, and the like, each of which is well known in the art and useful for operation of the computing device. Accordingly, while elements of the exemplary computing device 600 are described herein, they should be viewed as illustrative components and not the only components of the computing device.

Regarding the various components of the exemplary computing device 600, those skilled in the art will appreciate that these components may be implemented as executable software modules stored in the memory of the computing device, as hardware modules and/or components (including SoCs—system on a chip), or a combination of the two. Indeed, components such as the messaging service component 614, the workflow management component 416, and the information management application 618 may be implemented according to various executable embodiments including executable software modules that carry out one or more logical elements of the processes described in this document, or as a hardware components that include executable logic to carry out the one or more logical elements of the processes described in this document. Examples of these executable hardware components include, by way of illustration and not limitation, ROM (read-only memory) devices, programmable logic array (PLA) devices, PROM (programmable read-only memory) devices, EPROM (erasable PROM) devices, and the like, each of which may be encoded with instructions and/or logic which, in execution, carry out the functions described herein.

Moreover, in certain embodiments each of the various components of the exemplary computing device 600 may be implemented as an independent, cooperative process or device, operating in conjunction with or on one or more computer systems and or computing devices. It should be further appreciated, of course, that the various components described above should be viewed as logical components for carrying out the various described functions. As those skilled in the art will readily appreciate, logical components and/or subsystems may or may not correspond directly, in a one-to-one manner, to actual, discrete components. In an actual embodiment, the various components of each computing device may be combined together or distributed across multiple actual components and/or implemented as cooperative processes on a computer network.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for managing a workflow related to a user in regard to one or more received messages, the method comprising:
receiving a first message directed to the user;
identifying a first third party template associated with the user that is applicable to the first message according to an applicability condition of the first third party template;
identifying a first template rule of the first third party template that is applicable to the first message according to an analysis of the first message;
implementing a first action associated with the first template rule with regard to a workflow status of a workflow corresponding to the first third party template; and
updating the workflow status of the workflow according to the results of implementing the first action.

2. The computer-implemented method of claim 1, further comprising identifying the first third party template associated with the user that is applicable to the first message from a plurality of third party templates associated with the user.

3. The computer-implemented method of claim 2, further comprising:
identifying a plurality of third party templates are applicable to the first message from a plurality of third party templates associated with the user including the first third party template associate with the user; and
for each identified third party template:
identifying a template rule of the identified third party template that is applicable to the first message according to an analysis of the first message;
implementing an action associated with the identified template rule with regard to a workflow status of a workflow corresponding to the identified third party template; and
updating the workflow status of the workflow according to the implemented action.

4. The computer-implemented method of claim 3, further comprising:
identifying a plurality of template rules of at least one identified third party template that are applicable to the first message according to an analysis of the first message; and
for each template rule of the plurality of template rules:
implementing an action associated with the identified template rule with regard to a workflow status of a workflow corresponding to the at least one identified third party template; and
updating the workflow status of the workflow according to the implemented action.

5. The computer-implemented method of claim 1, wherein identifying the first template rule of the first third party template that is applicable to the first message according to an analysis of the first message comprises identifying the first template rule of the first third party template that is applicable to the first message according to an analysis of the first message and a condition of applicability of the first template rule.

6. The computer-implemented method of claim 5, wherein the condition of applicability of the first template rule comprises any one of a current value of an item of data in the workflow, a current value of an item of data within the receive message, a date associated with the received message, or a sender associated with the received message.

7. The computer-implemented method of claim 6 further comprises:
receiving a request for display information of the workflow status of the workflow corresponding to a third party template;
identifying a template rule for displaying workflow status of the workflow corresponding to a third party template;
generating display information of the workflow status of the workflow corresponding to a third party template; and
returning the generated display information in response to the request.

8. The computer-implemented method of claim 7, wherein identifying a template rule for displaying workflow status of the workflow corresponding to a third party template comprises identifying a template rule for displaying workflow status of the workflow corresponding to a third party template according to a condition associate with the template rule for displaying workflow status of the workflow.

9. The computer-implemented method of claim 8, wherein the display information comprises any one or more of executable code, executable scripts, audio/visual content, graphic, images, data values, hyperlinks to external content, lists and actionable controls.

10. A computer-readable medium bearing computer-executable instructions which, in execution on a computing system comprising at least a processor, configure the computing system to carry out a method for managing a workflow for a user in regard to one or more received messages, the method comprising:
receiving a first message directed to the user;
identifying a first third party template associated with the user that is applicable to the first message according to an applicability condition of the first third party template;
identifying a first template rule of the first third party template that is applicable to the first message according to an analysis of the first message;
implementing a first action associated with the first template rule with regard to a workflow status of a workflow corresponding to the first third party template; and
updating the workflow status of the workflow according to the results of implementing the first action.

11. The computer-readable medium of claim 10, the method further comprising identifying the first third party template associated with the user that is applicable to the first message from a plurality of third party templates associated with the user.

12. The computer-readable medium of claim 11, the method further comprising:
identifying a plurality of third party templates are applicable to the first message from a plurality of third party templates associated with the user including the first third party template associate with the user; and
for each identified third party template:
identifying a template rule of the identified third party template that is applicable to the first message according to an analysis of the first message;
implementing an action associated with the identified template rule with regard to a workflow status of a workflow corresponding to the identified third party template; and
updating the workflow status of the workflow according to the implemented action.

13. The computer-readable medium of claim 12, the method further comprising:
identifying a plurality of template rules of at least one identified third party template that are applicable to the first message according to an analysis of the first message; and
for each template rule of the plurality of template rules:
implementing an action associated with the identified template rule with regard to a workflow status of a workflow corresponding to the at least one identified third party template; and
updating the workflow status of the workflow according to the implemented action.

14. The computer-readable medium of claim 10, wherein identifying the first template rule of the first third party template that is applicable to the first message according to an analysis of the first message comprises identifying the first template rule of the first third party template that is applicable to the first message according to an analysis of the first message and a condition of applicability of the first template rule.

15. The computer-readable medium of claim 14, wherein the condition of applicability of the first template rule comprises any one of a current value of an item of data in the workflow, a current value of an item of data within the receive message, a date associated with the received message, or a sender associated with the received message.

16. The computer-readable medium of claim 15, wherein the method further comprises:
receiving a request for display information of the workflow status of the workflow corresponding to a third party template;
identifying a template rule for displaying workflow status of the workflow corresponding to a third party template;
generating display information of the workflow status of the workflow corresponding to a third party template; and
returning the generated display information in response to the request.

17. The computer-readable medium of claim 16, wherein identifying a template rule for displaying workflow status of the workflow corresponding to a third party template comprises identifying a template rule for displaying workflow status of the workflow corresponding to a third party template according to a condition associate with the template rule for displaying workflow status of the workflow.

18. The computer-readable medium of claim 17, wherein the display information comprises any one or more of executable code, executable scripts, audio/visual content, graphic, images, data values, hyperlinks to external content, lists and actionable controls.

19. A computing system for managing a workflow of a user in regard to one or more received messages, the system comprising a processor and a memory, wherein the processor executes instructions stored in the memory as part of or in conjunction with additional components to manage the workflow of the user, the additional components comprising:
a messaging service component, wherein the messaging service component is configured to provide a messaging service on the computing system;
a workflow management component, wherein the workflow management component is configured to provide a workflow management service on the computing system such that, upon notice of the messaging service receiving a message for the user, the workflow management service:
identify a first third party template associated with the user that is applicable to the received message according to an applicability condition of the first third party template;
identify a first template rule of the first third party template that is applicable to the first message according to an analysis of the received message;
implementing a first action associated with the first template rule with regard to a workflow status of a workflow corresponding to the first third party template; and
updating the workflow status of the workflow according to the results of implementing the first action.

20. The computing system of claim 19, wherein the workflow management service further identifies the first third party template associated with the user that is applicable to the first message from a plurality of third party templates associated with the user.
